(19) United States
(12) Patent Application Publication
(10) Pub. No.: US 2015/0314971 A1
(43) Pub. Date: Nov. 5, 2015

(54) WAFER CARRIER-RING LOADER FOR STANDARD SEMICONDUCTOR FACTORY INTERFACE

(71) Applicant: Applied Materials, Inc., Santa Clara, CA (US)

(72) Inventor: John Mazzocco, San Jose, CA (US)

(21) Appl. No.: 14/268,776

(22) Filed: May 2, 2014

(51) Int. Cl. B65G 65/00

(52) U.S. Cl. CPC B65G 65/00

(57) ABSTRACT

Embodiments of the invention include methods and apparatuses for transferring a workpiece from a workpiece carrier to a system load rack. The system load rack includes slots for holding workpieces that are spaced apart from each other by a pitch that is greater than the pitch of slots in the workpiece carrier. The increased pitch of the system load rack enables a factory interface to accommodate non-standard workpieces. A method for transferring the workpieces includes contacting the workpiece in a workpiece carrier with an end-effector. Thereafter, the workpiece is removed from the workpiece carrier with the end-effector. The end-effector inserts the workpiece into a system load rack. After removing the end-effector from the system load rack, the system may be indexed to prepare for transferring a subsequent workpiece.

### BACKGROUND

1) Field

Embodiments of the present invention pertain to the field of semiconductor processing and, in particular, to methods and apparatuses for transferring workpieces from a workpiece carrier to a processing tool.

2) Description of Related Art

Production scale semiconductor fabrication is typically performed in highly automated fabrication plants. An automated material handling system (AMHS) transfers workpieces, such as silicon wafers, between processing and metrology tools in workpiece carriers. For example, workpiece carriers may include front opening unified pods (FOUPs). A factory interface is added onto tools in order to interface with the AMHS. A wafer handling robot within the factory interface is designed to remove workpieces from the workpiece carrier and transfer the workpiece to the tool for processing.

A processing tool, such as processing tool 100 illustrated in FIG. 1A, may include a cluster tool 106, a laser scribe tool 108, or any other tool for processing substrates. A cluster tool 106 can include a plurality of processing tools, such as various etching and/or deposition chambers. For example, the overall footprint of such a processing tool may be approximately 3500 mm (3.5 meters) by 3800 mm (3.8 meters). Processing tool 100 also includes a factory interface assembly 111. The factory interface assembly 111 may include a factory interface 102 and one or more load ports 104. Each load port 104 is designed to receive a FOUP that stores a plurality of workpieces 122. For example, the workpieces 122 may be a 300 mm silicon wafer 122. Once the FOUP is docked onto a load port 104, the workpieces 122 inside each FOUP are accessible to a wafer handling robot within the factory interface 102.

FIG. 1B is a cross-sectional view of a FOUP 109 that is accessible to the factory interface 102. FOUP 109 includes a plurality of slots 120 for storing substrates 122 inside of a protective chamber 142. For example a FOUP 109 may have 25 or more slots 120. A FOUP 109 designed for use with 300 mm wafers, will have slots 120 that are spaced apart from each other by a pitch P of approximately 10 mm. The thickness of the workpieces 122 is smaller than the pitch P of the slots 120. For example, a 300 mm wafer may have a thickness of approximately 775 μm or less. The wafer handling robot in the factory interface 102 is designed to be able to remove substrates 122 that are spaced apart from each other by approximately 9 mm or greater.

When non-standard workpieces 122 are used, the factory interface 102 may not be able to accommodate the different dimensions. For example, the slots 120 of a standardized workpiece carrier may not be spaced at a pitch P large enough to allow a wafer handling robot to access non-standardized workpieces that are thicker than a commercially available silicon wafer. The increased thickness reduces the clearance between workpieces available to a wafer handling robot within the factory interface 102. Accordingly, the factory interface 102 may not be able to remove non-standard workpieces from a standard workpiece carrier.

### SUMMARY

Embodiments of the invention include methods and apparatuses for transferring a workpiece from a workpiece carrier to a system load rack in a loader interface that is coupled to a factory interface.

An embodiment includes a method for transferring a workpiece from a workpiece carrier to a system load rack that involves contacting a workpiece in a workpiece carrier with an end-effector. The end effector may be coupled to an exchange robot. The workpiece is positioned in one of a plurality of workpiece carrier slots spaced apart from each other by a first pitch of 10 mm or less. The method also involves removing the substrate from the workpiece carrier with the end-effector. The method also involves inserting the workpiece into a system load rack with the end-effector. The system load rack has a plurality of system load rack slots that are spaced apart from each other by a second pitch that is larger than the first pitch. The second pitch may be between 15 mm and 20 mm. The method also involves removing the end-effector from the system load rack and indexing the components to prepare for transferring a subsequent workpiece.

An additional embodiment includes a loader interface apparatus. The loader interface includes a first docking station for receiving one or more workpiece carriers. In embodiments, the workpiece carries have a plurality of workpiece carrier slots spaced apart by a first pitch that is 10 mm or less. In embodiments, the loader interface may also include a system load rack with a plurality of system load rack slots each sized for receiving a workpiece. The plurality of system load rack slots are spaced apart by a second pitch that is greater than the first pitch. In embodiments, the loader interface may also include a first exchange robot having an end-effector sized to transfer a workpiece stored in a workpiece carrier to one of the system load rack slots in the system load rack. In an embodiment the workpiece includes a carrier ring, a substrate, and a backing tape. In an embodiment, the thickness of the workpiece may be 1.0 mm or greater.

### BRIEF DESCRIPTION OF THE DRAWINGS

FIG. 1A is an illustration of a block diagram of a processing tool that includes a factory interface and a plurality of load ports.

FIG. 1B is an illustration of a cross-sectional view of a front opening unified pod (FOUP).

FIG. 2 illustrates a plan view of a substrate carrier for supporting a substrate during processing operations, in accordance with an embodiment of the invention.

FIG. 3A illustrates a block diagram of a factory interface assembly that includes a factory interface and a loader interface, in accordance with an embodiment of the invention.

FIG. 3B illustrates a cross-sectional view of a system load rack included in a loader interface, in accordance with an embodiment of the invention.

FIG. 3C illustrates a cross-sectional view of the system load rack of FIG. 3B along the line C-C, in accordance with an embodiment of the invention.

FIG. 3D is an illustration of a block diagram of a processing tool that includes a factory interface and loader interface, in accordance with an embodiment of the invention.

FIGS. 3E-3G illustrate cross-sectional views of a semiconductor wafer including a plurality of integrated circuits during a method of dicing a semiconductor wafer, in accordance with an embodiment of the invention.

FIG. 4 is a flowchart representing operations in a method for transferring a workpiece from a workpiece carrier to a system load rack, in accordance with an embodiment of the invention.

FIGS. 5A-5F illustrate a schematic block diagram of a process for transferring a workpiece from a workpiece carrier to a system load rack, in accordance with an embodiment of the invention.

FIGS. 6A-6E illustrate a schematic block diagram of a process for transferring a workpiece from a workpiece carrier to a system load rack, in accordance with an embodiment of the invention.

FIGS. 7A-7C illustrate a schematic block diagram of a process for transferring a workpiece from a workpiece carrier to a system load rack, in accordance with an embodiment of the invention.

FIG. 8 illustrates a schematic block diagram of an apparatus for transferring a workpiece from a workpiece carrier to a system load rack, in accordance with an embodiment of the invention.

FIG. 9 illustrates a schematic block diagram of an apparatus for transferring a workpiece from a workpiece carrier to a system load rack, in accordance with an embodiment of the invention.

FIG. 10 illustrates a schematic block diagram of an apparatus for transferring a workpiece from a workpiece carrier to a system load rack, in accordance with an embodiment of the invention.

FIG. 11 illustrates a block diagram of an exemplary computer system, in accordance with an embodiment of the invention.

### DETAILED DESCRIPTION

Methods and apparatuses used for transferring a workpiece from a workpiece carrier having a first pitch to a system load rack having a second pitch that is larger than the first pitch are described in accordance with various embodiments. In the following description, numerous specific details are set forth, such as substrates supported by a carrier ring, workpiece carriers, and semiconductor processing tools, in order to provide a thorough understanding of embodiments of the present invention. It will be apparent to one skilled in the art that embodiments of the present invention may be practiced without these specific details. In other instances, well-known aspects are not described in detail in order to not unnecessarily obscure embodiments of the invention. Furthermore, it is to be understood that the various embodiments shown in the Figures are illustrative representations and are not necessarily drawn to scale.

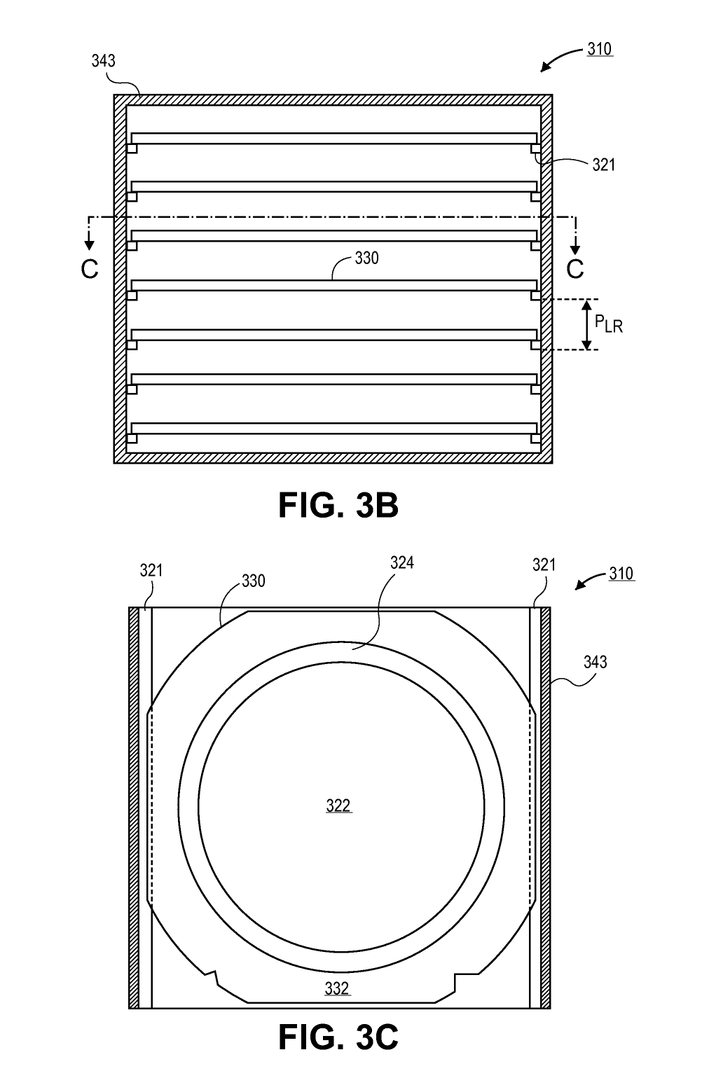

In an embodiment, a loader interface is described that allows a processing tool to accommodate workpieces that do not match the design specifications of a factory interface included in the processing tool. For example, a workpiece 230, illustrated in FIG. 2, may be processed by a tool that has a factory interface designed for processing 300 mm wafers. In an embodiment, workpiece 230 includes a carrier ring 232 designed for carrying a substrate 222. In an embodiment, the carrier ring 232 is a metallic material. For example, the carrier ring 232 is a stainless steel. In alternative embodiments, the carrier ring 232 may also be plastic, resin, or glass. For example, a carrier ring 232 may be a borosilicate glass. In an embodiment, workpiece 230 includes a layer of adhesive backing tape 224 surrounded by the carrier ring 232. The substrate 222 is supported by the backing tape 224 of the workpiece 230. In an embodiment, the substrate 222 is a commercially available silicon wafer, such as a 300 mm silicon wafer. Substrate 222 may have a plurality of individual device dies (not shown) that each include integrated circuitry formed thereon. In an embodiment, carrier ring 232 has a diameter of approximately 380 mm, though embodiments are not limited to such configurations. For example, a carrier ring 232 for carrying a larger silicon wafer may have a diameter greater than 380 mm. In an embodiment, carrier ring 232 includes flat edges, rounded edges, and notches. Additional embodiments include a substantially circular carrier ring.

In an embodiment the thickness of the carrier ring 232 is greater than the thickness of the substrate 222. By way of example, the thickness of the carrier ring may be 1.0 mm or greater. For example, the thickness of the carrier ring 232 may be between 1.0 mm and 5.0 mm. In an additional embodiment, the thickness of a carrier ring 232 is not as uniform as a commercially available silicon wafer. For example, the variation in thickness across a carrier ring 232 may be 0.2 mm or greater. Furthermore, the increased diameter of the workpiece 230 increases the amount of droop. Since the slots of a workpiece carrier only support the workpiece 230 along the edges, the effect of gravity produces a drooping effect across the unsupported span of the workpiece. Accordingly, the accumulated effect of the increased thickness, the reduction in thickness uniformity, and the increased degree of drooping decreases the spacing between workpieces 230 stored in a workpiece carrier. For example, the clearance between neighboring workpieces 230 may be less than approximately 5.0 mm. In an embodiment, the clearance between neighboring workpieces 230 may be approximately 1.0 mm. Accordingly, standard wafer handling robots in the factory interface are not able to reliable remove workpieces 230 stored in workpiece carriers that have slots that are spaced apart by pitches of 10 mm or less.

While specific reference is made herein to workpieces 330 that include a carrier ring 232, embodiments are not so limited. Substantially similar methods and apparatuses to those described herein may be used to transfer other workpieces 330 that have a thickness that is greater than what can be accommodated by the factory interface. For example, glass substrate carriers may be transferred according to embodiments of the invention. Additionally, carrier rings 232 for carrying multiple substrates may be transferred according to embodiments of the invention. For example, carrier rings 232 utilized for processing light emitting diodes (LEDs) formed on a plurality of sapphire substrates may be transferred according to embodiments of the invention.

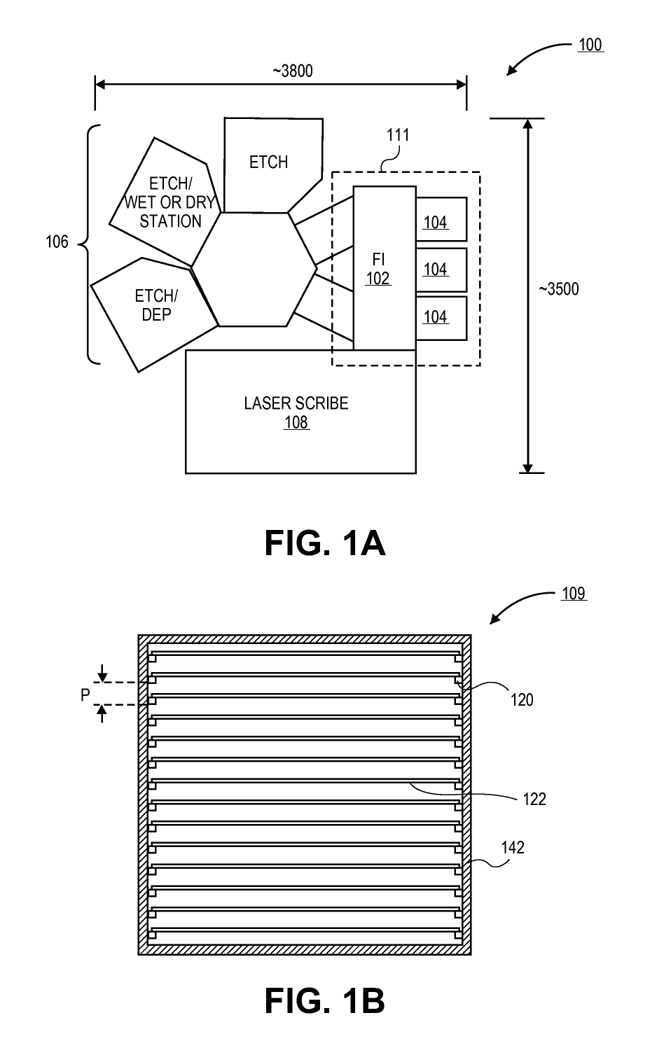

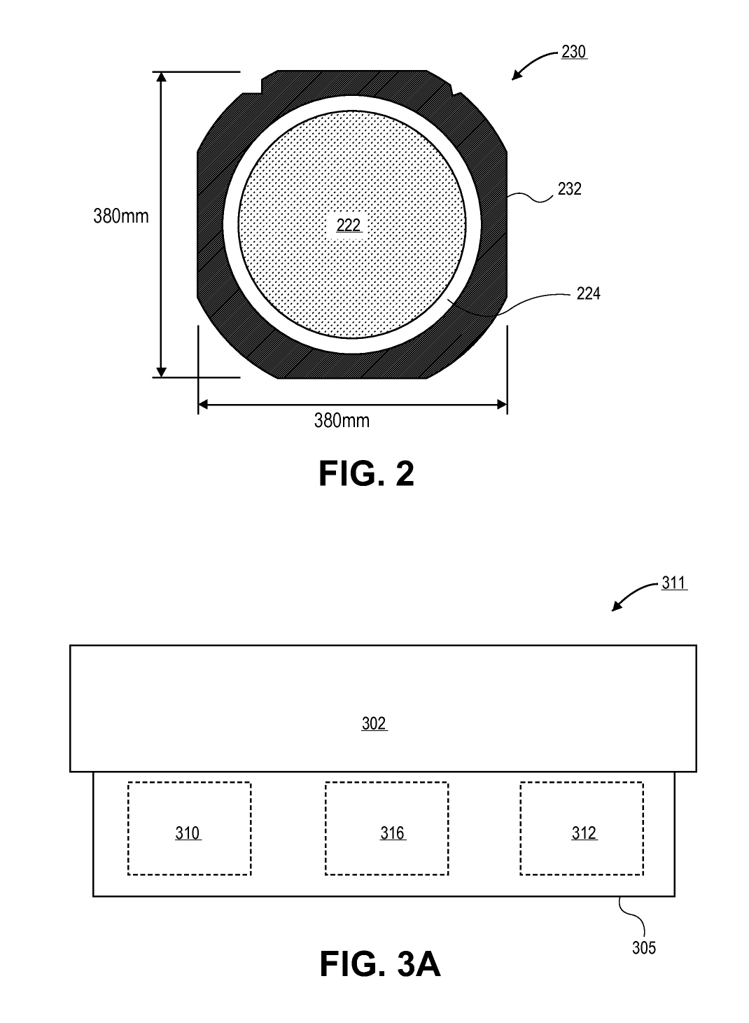

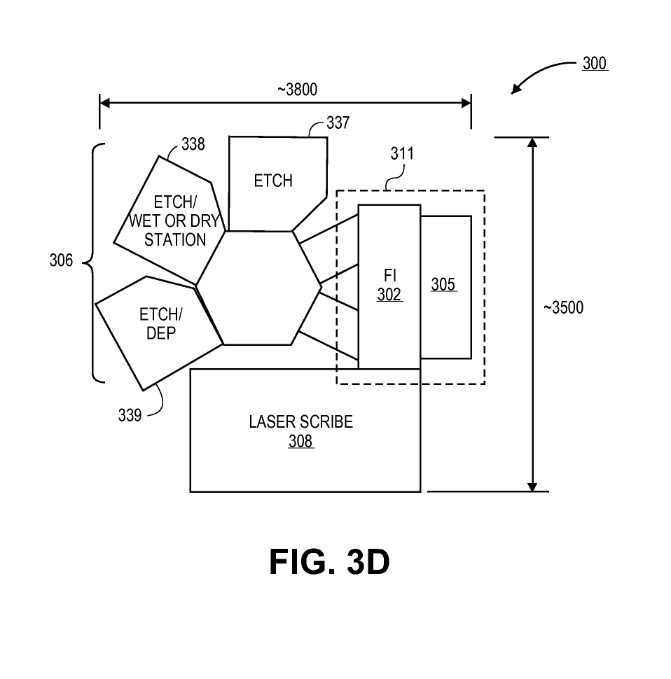

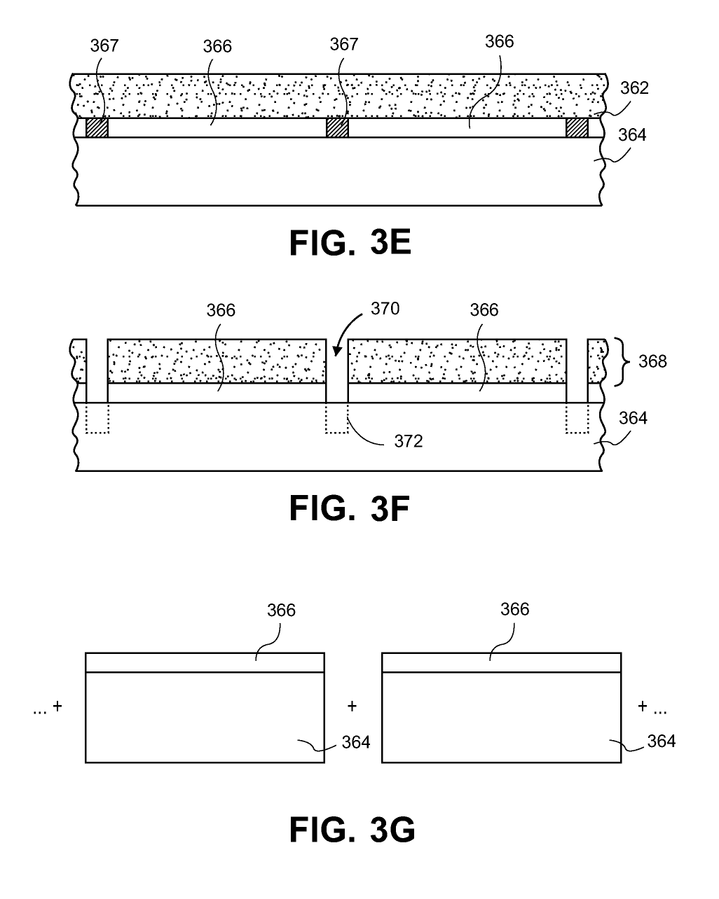

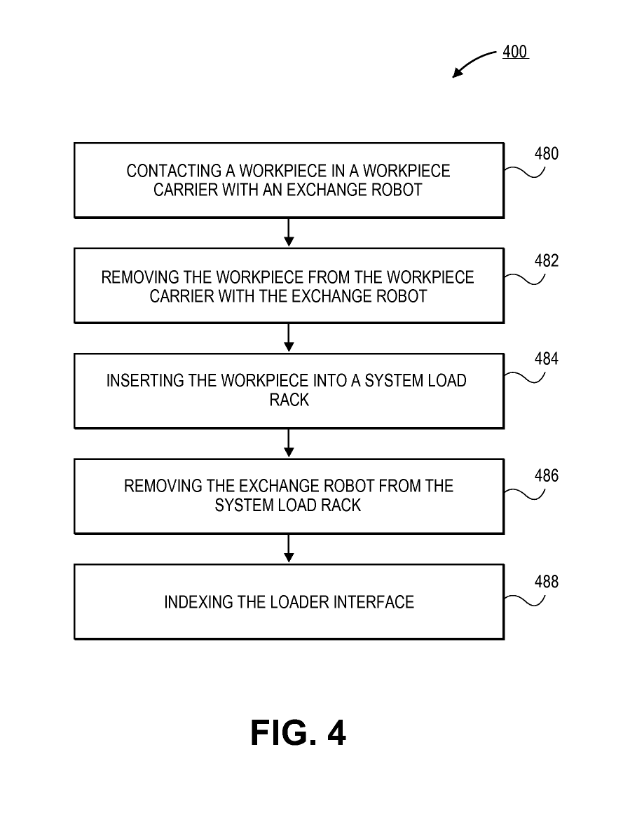

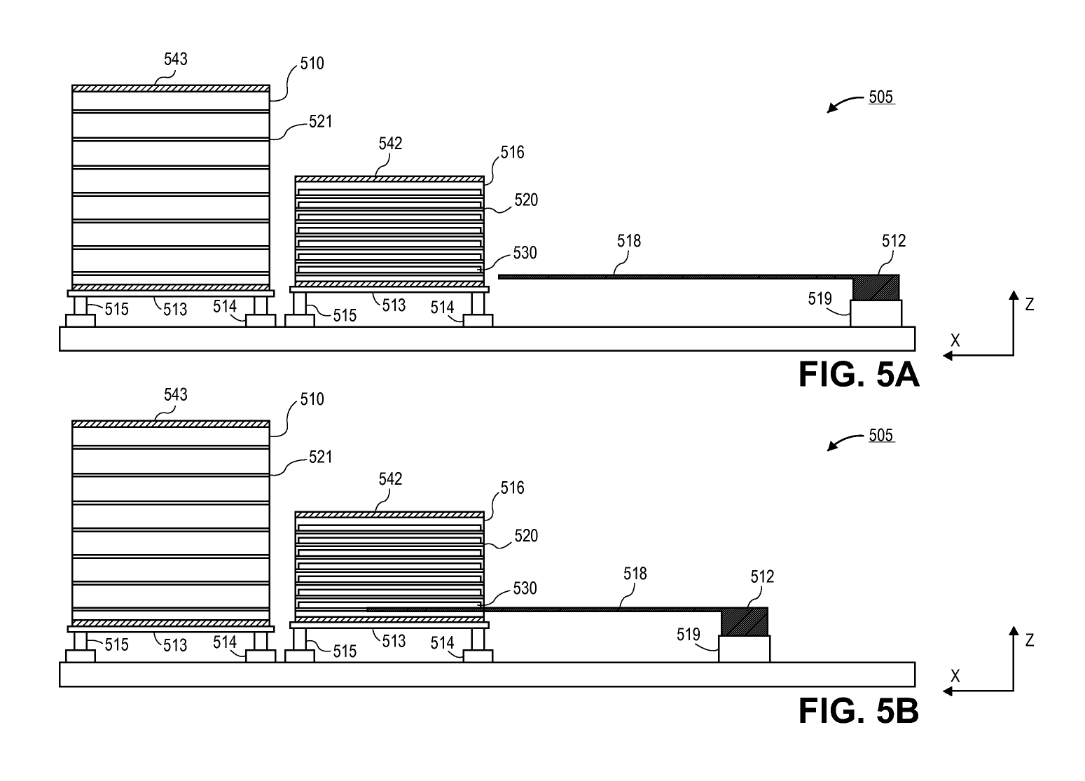

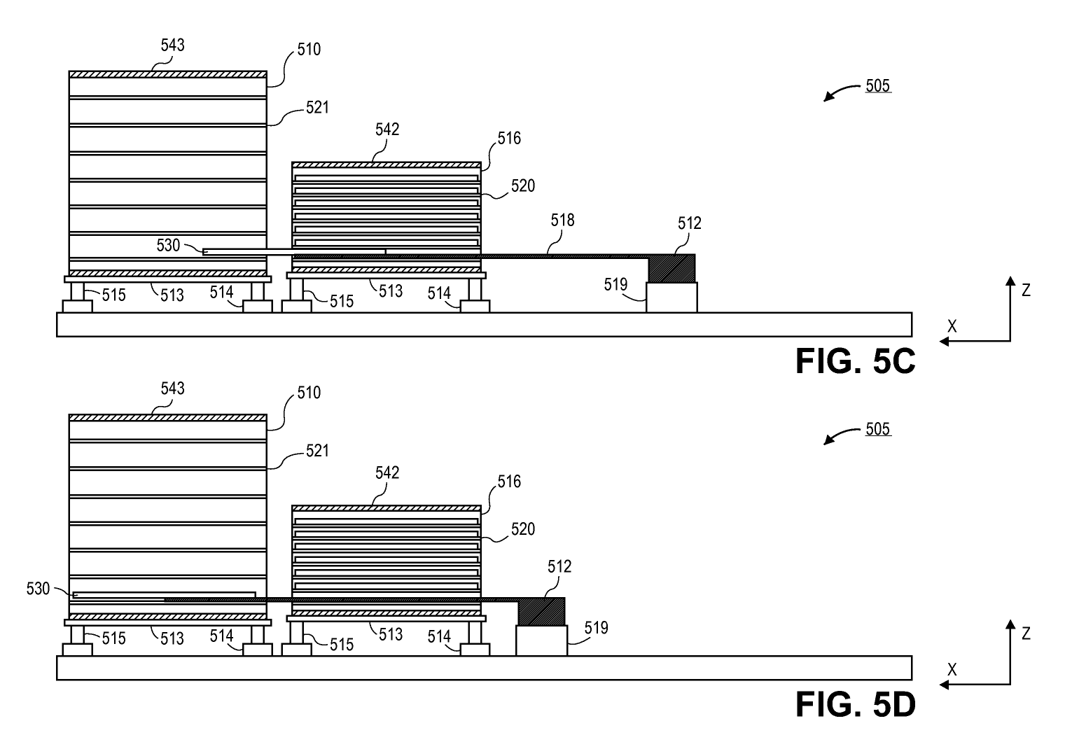

Referring now to FIG. 3A, an overhead block diagram of a factory interface assembly 311 that includes a loader interface 305 and a factory interface 302 according to an embodiment is provided. The factory interface 302 is substantially similar to the one described above with respect to FIG. 1A. In an embodiment, factory interface 302 includes a wafer handling robot (not shown) that transfers workpieces from the loader interface 305 to a processing tool. The loader interface 305 replaces the FOUP load ports 104. In an embodiment, the loader interface 305 extends out from the factory interface a distance equal to or less than the width of the load ports 104 shown in FIG. 1A. By way of example, the loader interface 305 may extend out from the factory interface 302 less than approximately 450 mm or less. Accordingly, replacing the load ports 104 with the loader interface 305 does not require an increase in the footprint of the processing tool. In an embodiment, the loader interface 305 includes one or more system load racks 310, one or more exchange robots 312, and one or more workpiece carriers 316. In FIG. 3A, the system load rack 310, the exchange robot 312 and the workpiece carrier 316 are represented schematically as dashed boxes. As will become apparent in the description below, the arrangement and quantity of each feature is not limited to the arrangement and quantity illustrated in FIG. 3A.

In an embodiment, the workpiece carriers 316 are standardized workpieces carriers, such as a cassette or a FOUP. By way of example, the workpiece carriers may have a plurality of slots 320, each spaced apart from each other by a pitch that is approximately 10 mm, as described above. Accordingly, a wafer handling robot in the factory interface 302 may not be able to reliably remove an individual workpiece 330 from the workpiece carrier 316 due to the decrease in the clearance between the thicker workpieces 330. For example, the workpieces 330 may include a carrier ring 332, backing tape 324, and a substrate 322.

In order to allow the wafer handling robot of the factory interface to access and remove individual workpieces 330, the workpieces 330 are transferred to system load racks 310, such as the one illustrated in FIG. 3B. In an embodiment, a system load rack 310 has slots 321 for receiving workpieces 330. For example, the system load rack 310 may include 10 or more slots 321. In an embodiment, the system load rack 310 may include 25 or more slots 321. The slots 321 in the system load rack are spaced apart by a pitch P_{LR} that is greater than 10 mm. In an embodiment, the system load rack may have slots with a pitch P_{LR} that is between 15 mm and 20 mm. The additional space between the workpieces 330 allows a standard wafer handling robot within a factory interface 302 to reliably remove the thicker workpieces 330 without contacting neighboring workpieces 330.

FIG. 3C is a cross-sectional illustration of FIG. 3B along line C-C, according to an embodiment. As shown, the slots 321 run along sidewalls of the system load rack 310. In an embodiment, a protective shell 343 may be formed along the sidewalls on which the slots 321 are formed with the remaining sides left open. In an embodiment, an opening may be formed along a single side of the system load rack 310. In an embodiment, no protective shell is included around the system load rack 310. Once the workpieces are transferred to the system load rack 310, the wafer handling robot of the factory interface 302 has sufficient clearance between workpieces 330 to transfer them from the system load rack 310 to the process tool. As such, expensive redesign of a factory interface 302 or replacement of the factory interface 302, is not needed in order to accommodate workpieces 330 that have a thickness that is greater than the substrates that the factory interface 302 was designed to receive.

Referring now to FIG. 3D, a process tool 300 that includes a factory interface assembly 311 with a factory interface 302 and a loader interface 305 is shown according to an embodiment. The process tool 300 may include a cluster tool 306 that is coupled to the factory interface 303. The cluster tool 306 includes one or more plasma etch chambers 337. In an embodiment, the process tool 300 includes a laser scribe apparatus 308. A process tool 300 may be configured to perform a hybrid laser and etch singulation process of individual device dies formed on a substrate 222, such as a silicon wafer that is supported by a carrier ring 232.

In an embodiment, the laser scribe apparatus 308 houses a femtosecond-based laser. The femtosecond-based laser may be suitable for performing a laser ablation portion of a hybrid laser and etch singulation process of individual device dies formed on a substrate 222, such as a silicon wafer that is supported by a carrier ring 232. In one embodiment, a moveable stage is also included in the laser scribe apparatus 308, the moveable stage configured for moving a substrate 222 supported by a carrier ring 232 relative to the femtosecond-based laser. In another embodiment, the femtosecond-based laser is also moveable.

In an embodiment, the one or more plasma etch chambers 337 in the cluster tool 306 may be suitable for performing an etching portion of a hybrid laser and etch singulation process of individual device dies formed on a substrate 222, such as a silicon wafer that is supported by a carrier ring 232. An etch chamber may be configured for etching a substrate 222 supported by a carrier ring 232 through the gaps in a patterned mask. In one such embodiment, the one or more plasma etch chambers 337 in the cluster tool 306 is configured to perform a deep silicon etch process. In a specific embodiment, the one or more plasma etch chambers is an Applied Centura® Silvia™ Etch system, available from Applied Materials of Sunnyvale, Calif., USA. The etch chamber may be specifically designed for a deep silicon etch used to singulated integrated circuits housed on or in single crystalline silicon substrates or wafers. In an embodiment, a high-density plasma source is included in the plasma etch chamber to facilitate high silicon etch rates.

In an embodiment, the factory interface 302 may be a suitable atmospheric port to interface with the loader interface 305 and with the laser scribe tool 308 and the cluster tool 306. The factory interface 302 may include one or more robots with arms or blades for transferring workpieces 230 from system load racks 310 in the loader interface 305 into either cluster tool 306 or laser scribe apparatus 308, or both.

Cluster tool 306 may include other chambers suitable for performing functions in a method of singulation. For example, in one embodiment, in place of an additional etch chamber, a deposition chamber 339 is included. The deposition chamber 339 may be configured for mask deposition on or above a device layer of a wafer or a substrate prior to laser scribing of the wafer or substrate. In one such embodiment, the deposition chamber 339 is suitable for depositing a water soluble mask. In another embodiment, in place of an additional etch chamber, a wet/dry 338 station is included. The wet/dry station 338 may be suitable for cleaning residues and fragments, or for removing a water soluble mask, subsequent to a laser scribe and plasma etch singulation process of a substrate or a wafer. In an embodiment, a metrology station is also included as a component of process tool 300.

According to an embodiment, a hybrid laser and etch singulation process may include a process such as the one illustrated in FIGS. 3E-3G. Referring to FIG. 3E, a mask 362 is formed above a semiconductor wafer or substrate 364. The mask 362 is composed of a layer covering and protecting integrated circuits 366 formed on the surface of semiconductor wafer 364. The mask 362 also covers intervening streets 367 formed between each of the integrated circuits 366.

Referring to FIG. 3F, the mask 362 is patterned with a laser scribing process to provide a patterned mask 368 with gaps 370, exposing regions of the semiconductor wafer or substrate 364 between the integrated circuits 366. As such, the laser scribing process is used to remove the material of the streets 367 originally formed between the integrated circuits 366. In accordance with an embodiment of the present invention, patterning the mask 362 with the laser scribing process further includes forming trenches 372 partially into the regions of the semiconductor wafer 364 between the integrated circuits 366, as depicted in FIG. 3F.

Referring to FIG. 3G, the semiconductor wafer 364 is etched through the gaps 370 in the patterned mask 368 to singulate the integrated circuits 366. In accordance with an embodiment of the present invention, etching the semiconductor wafer 364 includes ultimately etching entirely through semiconductor wafer 364, as depicted in FIG. 3G, by etching the trenches 372 initially formed with the laser scribing process. In one embodiment, the patterned mask 368 is removed following the plasma etching, as is also depicted in FIG. 3G.

Accordingly, referring again to FIGS. 3E-3G, wafer dicing may be performed by initial ablation using a laser scribing process to ablate through a mask layer, through wafer streets (including metallization) and, possibly, partially into a substrate or wafer. Die singulation may then be completed by subsequent through-substrate plasma etching, such as through-silicon deep plasma etching.

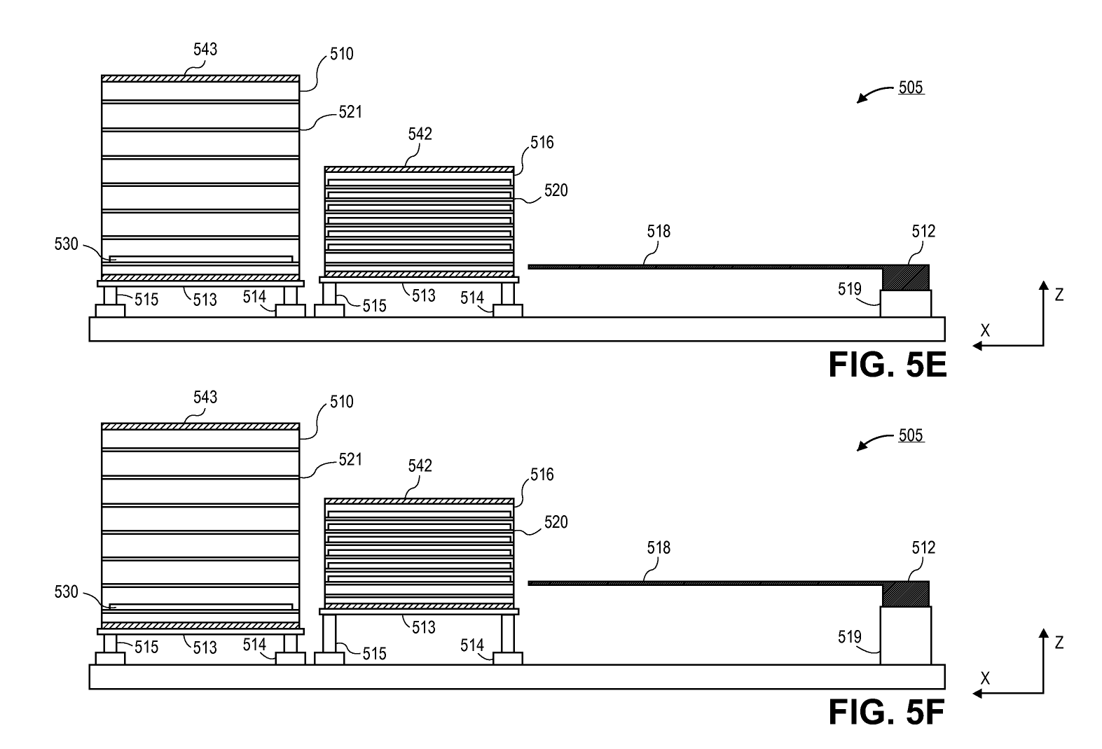

According to embodiments, workpieces are transferred from a workpiece carrier to a system load rack with an exchange robot. FIG. 4 includes a flowchart 400 representing operations in a process for transferring workpieces from the workpiece carrier to the system load rack. Embodiments include various configurations of the system load rack, the exchange robot, and the workpiece carrier that may be used in accordance with the operations described in flowchart 400.

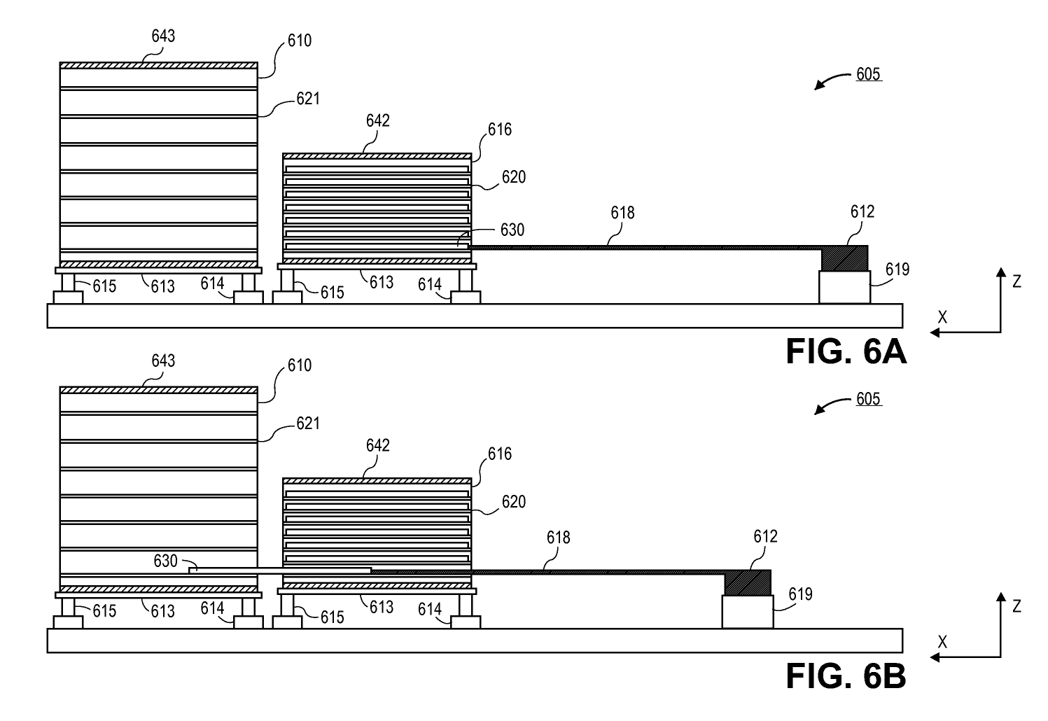

FIGS. 5A-5D illustrate schematic cross-sectional views of a loader interface 505 during performance of a process for transferring workpieces 530 from the workpiece carrier 516 to the system load rack, corresponding to operations of flowchart 400, in accordance with an embodiment. In FIG. 5A, the system load rack 510 is positioned on a first side of the loader interface 505. An exchange robot 512 is positioned on a second side of the loader interface that is opposite to the first side of the loader interface 505. A workpiece carrier 516 is positioned between the exchange robot 512 and the system load rack 510.

In an embodiment, the workpiece carrier is supported by a docking station 513. The docking station 513 is coupled to one or more indexing mechanisms 514. The indexing mechanism 514 displaces the docking station 513 in the Z-direction. In an embodiment, the indexing mechanism 514 includes an actuator 515 that can extend or retract in the Z-direction. For example, the actuator may be a hydraulic actuator or a mechanical actuator. Embodiments may include actuators such as a hydraulic piston or a lead screw. The docking station 513 in FIG. 5A includes two indexing mechanisms 514 that work together to displace the workpiece carrier 516 in the Z-direction, though embodiments are not limited to such configurations. Alternative embodiments include a docking station 513 that is not supported by any indexing mechanisms 514. For example, in embodiments that include an indexable system load rack 510, the docking station on which the workpiece carrier 516 is supported does not need to be able to be displaced in the Z-direction in order to transfer workpieces 530.

In an embodiment, workpiece carrier 516 includes a plurality of slots 520 for supporting workpieces 530. By way of example, the workpiece carrier 516 may have ten or more slots 520. Additional embodiments include workpiece carriers 516 that include twenty-five slots 520. Certain embodiments include a workpiece carrier 516 that includes slots 520 that are spaced apart from each other by a pitch that does not provide sufficient clearance for a wafer handling robot in the factory interface 502 to remove workpieces 530. For example, the pitch of the slots 520 in the workpiece carrier 516 is 10 mm or less. In an embodiment, the workpiece carrier 516 includes a protective enclosure 542. In the embodiment illustrated in FIG. 5A, the protective enclosure 542 is formed on the top and bottom surfaces of the workpiece carrier 516 and provides openings along the vertical sidewalls. The sidewall openings allow paths for the exchange robot 512 and the workpieces 530 to pass through during the transfer process. According to an embodiment, a workpiece carrier 516 with two openings may be a cassette.

According to an embodiment, a system load rack 510 substantially similar to the system load rack 310 described above with respect to FIGS. 3B and 3C is positioned on a second docking station 513. In an embodiment the system load rack 510 is indexable in the Z-direction. For example, the docking station 513 may be supported by one or more indexing mechanisms 514. The indexing mechanisms may be substantially similar to those described above with respect to the first docking station 513 that supports the workpiece carrier 516.

In an embodiment, the exchange robot 512 includes an end-effector 518. Embodiments include an end-effector 518 that has a length greater than the maximum width of the docking station 513. In an embodiment, end-effector 518 has a length that is sufficient to extend through the workpiece carrier 516 and into the system load rack 510. The end-effector 518 is formed from a rigid material. In an embodiment, the end-effector may be a metallic material, a composite material, a ceramic material, or any combinations thereof. By way of example, and not by way of limitation, the end-effector 518 may be aluminum, nickel plated aluminum, anodized aluminum, carbon fiber, alumina, or titanium doped alumina. In an embodiment, the exchange robot 512 may be displaced in the X and Z-directions by moving the robot mount 519. By way of example, and not by way of limitation, the robot mount 519 may be displaced in the X and Z-directions by actuators. For example, the actuator may be a hydraulic actuator or a mechanical actuator. Embodiments may include actuators such as a hydraulic piston or a lead screw.

Referring now to operation 480 of flowchart 400, and corresponding FIG. 5B, the exchange robot 512 contacts a workpiece 530 stored in the workpiece carrier 516. In an embodiment, contacting the workpiece 530 includes inserting the end-effector 518 into the workpiece carrier 516 below a workpiece 530. In such embodiments, the end effector 518 may be raised in the Z-direction to contact a bottom surface of the workpiece 530.

Referring now to operation 482 of flowchart 400, and corresponding FIG. 5C, the exchange robot 512 removes the workpiece 530 from the workpiece carrier 516. In an embodiment, removing the workpiece 530 from the workpiece carrier 516 includes lifting the workpiece off of the slot 520 by displacing the exchange robot 512 in the Z-direction. In an embodiment, removing the workpiece 530 includes moving the exchange robot 512 in the X-direction towards the workpiece carrier 516. As the exchange robot 512 moves towards the workpiece carrier 516, the end-effector 518 advances the workpiece 530 out the opening of the workpiece carrier 516 that is opposite to the exchange robot 512. In an embodiment, friction provides sufficient force to secure the workpiece 530 to the end-effector 518 during the transfer process. In an additional embodiment, the end-effector 518 includes a vacuum or an electro-magnetic gripping component to secure the workpiece 530 during the transfer process. Lifting the workpiece 530 off of the slots 520 reduces particle production that may otherwise occur if the workpiece 530 is dragged or pushed along slots 520.

Referring now to operation 484 of flowchart 400, and corresponding FIG. 5D, the exchange robot 512 inserts the workpiece 530 into the system load rack 510 through a sidewall opening of the system load rack 510. Once the workpiece 530 is fully inserted into the system load rack 510, the exchange robot 512 is lowered in the Z-direction to allow the workpiece 530 to rest on a slot 521. As described above, the system rack 510 includes slots 521 with a pitch that is greater than 10 mm. In an embodiment, the slots 521 have a pitch that is between 15 mm and 20 mm. The increased pitch of the slots 521 in the system load rack 510 provides adequate spacing to allow a factory interface wafer handling robot to reliably pick up individual workpieces 530.

Referring now to operation 486 of flowchart 400, and corresponding FIG. 5E, the end-effector 518 is removed from the system load rack 510 and the workpiece carrier 516 by retracting the exchange robot 512 along the X-direction. Referring now to operation 488 of flowchart 400, and corresponding FIG. 5F, the loader interface 505 is then indexed in order to prepare for transferring another workpiece 530. In an embodiment, the exchange robot 512 and the workpiece carrier 516 are indexed in the Z-direction. For example, the docking station 513 that supports the workpiece carrier 516 is raised in the Z-direction by the indexing mechanism 514 in order to align an occupied slot 520 of the workpiece carrier 516 with an empty slot 521 of the system load rack 510. In such embodiments, the exchange robot 512 is also indexed to align the end effector 518 so that it may be inserted into the workpiece carrier 516 below the next workpiece 530 that will be transferred. In an additional embodiment, the system load rack 510 may be indexed in the Z-direction in order to align an open system load rack slot 521 with a slot 520 that houses the next workpiece 530 that will be transferred. Indexing the loader interface 505 may also include raising and/or lowering both the system load rack 510 and the workpiece carrier 516 in order to align an occupied slot 520 in the workpiece carrier 516 with an empty slot 521 in the system load rack 510.

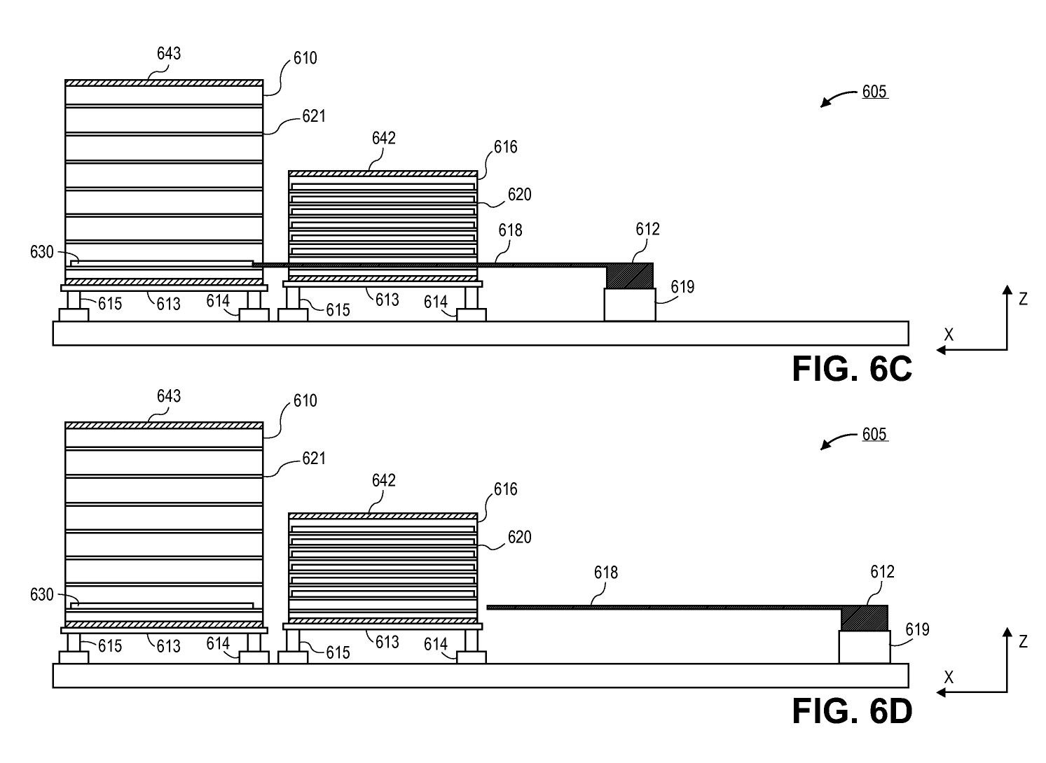

FIGS. 6A-6E illustrate cross-sectional views of a loader interface 602 during performance of a process for transferring workpieces 630 from the workpiece carrier 616 to the system load rack 610, corresponding to operations of flowchart 400, in accordance with an additional embodiment.

In an embodiment illustrated in FIG. 6A, the system load rack 610 is positioned on a first side of the loader interface 605. An exchange robot 612 is positioned on a second side of the loader interface that is opposite to the first side of the loader interface 605. A workpiece carrier 616 is positioned between the exchange robot 612 and the system load rack 610. The system load rack 610, the workpiece carrier 616 and the exchange robot 612 may be substantially similar to the ones described above with respect to FIG. 5A.

Referring now to operation 480 of flowchart 400, and corresponding FIG. 6A, the exchange robot 612 contacts the workpiece 630. In an embodiment, contacting the workpiece 630 includes inserting the end-effector 618 into the workpiece carrier 616 and contacting an edge of the workpiece 630. According to an embodiment, the end-effector 618 includes a gripping mechanism for securing the workpiece 630. By way of example, and not by way of limitation, the gripping mechanism may us a mechanical gripping force, an electromagnetic gripping force, or a vacuum gripping force to secure the edge of the workpiece 630. Contacting the edge of the workpiece 630 eliminates the need to displace the exchange robot in the Z-direction in order to transfer the workpiece 630 from the workpiece carrier 616 to the system load rack 610.

Referring now to operation 482 of flowchart 400, and corresponding FIG. 6B, the exchange robot 612 removes the workpiece 630 from the workpiece carrier 616. In an embodiment, removing the workpiece 630 includes displacing the robot mount 619 in the X-direction towards the workpiece carrier 616. As the robot mount is displaced towards the workpiece carrier 616, the end-effector 618 pushes the workpiece 630 along the slot 620 and out the opening of the workpiece carrier 616 that is opposite to the exchange robot 612. In an embodiment, the system load rack 610 and the workpiece carrier 616 are spaced close enough together for the workpiece 630 to be transferred between the two without needing to support the bottom surface of the workpiece 630. For example, when the distance between the workpiece carrier 616 and the system load rack 610 is less than the diameter of the workpiece 630, the workpiece can span between the workpiece carrier 616 and the system load rack 610 and be supported below by slots 620 and 621 on either side, as illustrated in FIG. 6B. In an additional embodiment, rails are included between the workpiece carrier 616 and the system load rack 610 in order to provide support to the bottom surface of the workpiece 630 as it is being transferred from the workpiece carrier 616 to the system rack 610.

Referring now to operation 484 of flowchart 400, and corresponding FIG. 6C, the exchange robot 612 inserts the workpiece 630 into the system load rack 610. As shown, the end-effector 618 continues pushing the workpiece 630 into the system load rack 610 until the workpiece 630 is completely supported by a slot 621. As described above, the system rack 610 includes slots 621 with a pitch that is greater than 10 mm. In an embodiment, the slots 621 have a pitch that is between 15 mm and 20 mm. The increased pitch of the slots 621 in the system load rack 610 provides adequate spacing to allow a factory interface wafer handling robot to reliably pick up individual workpieces 630.

Referring now to operation 486 of flowchart 400, and corresponding FIG. 6D, the end-effector 618 is removed from the system load rack 610. Removing the end-effector 618 may include retracting the end-effector 618 back through the workpiece carrier 616 by displacing the exchange robot 612 in the X-direction. Referring now to operation 488 of flowchart 400, and corresponding FIG. 6E, the loader interface 605 may be indexed in order to prepare for transferring another workpiece 630 from the workpiece carrier 616 to the system load rack 610. In an embodiment, the exchange robot 612 and the workpiece carrier 616 are indexed in the Z-direction in order to align an occupied slot 620 of the workpiece carrier 616 with an empty slot 621 of the system load rack 610. In such embodiments, the end effector 618 is aligned with a side of the next workpiece 630 that will be transferred. In an additional embodiment, the system load rack 610 may be indexed in the Z-direction in order to align an open system load rack slot 621 with a slot 620 that houses the next workpiece 630 that will be transferred. Indexing the loader interface 605 may also include raising and/or lowering both the system load rack 610 and the workpiece carrier 616 in order to align a slot 620 supporting a workpiece 630 with an empty slot 621 in the system load rack 610.

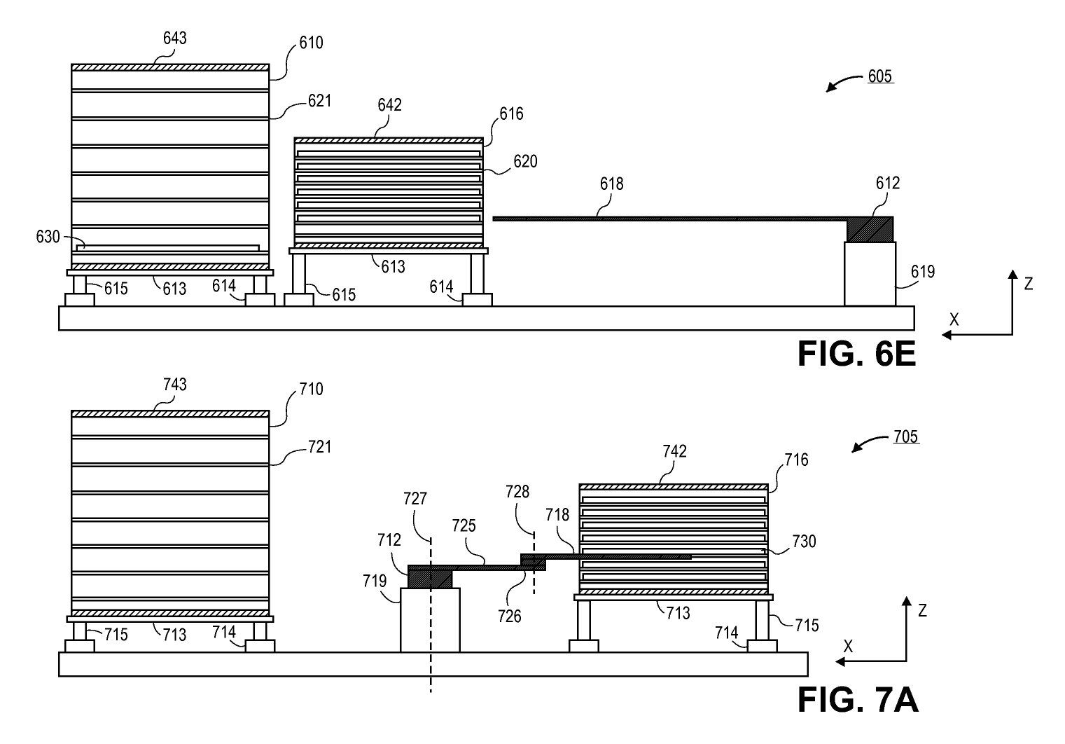

FIGS. 7A-7C illustrate cross-sectional views of a loader interface 705 during performance of a process for transferring workpieces 730 from the workpiece carrier 716 to the system load rack 710, corresponding to operations of flowchart 400, in accordance with an embodiment.

In an embodiment illustrated in FIG. 7A, the system load rack 710 is positioned on a first side of the loader interface 705. A workpiece carrier 716 is positioned on a second side of the loader interface 705 that is opposite to the first side of the loader interface 705. An exchange robot 712 is positioned between the workpiece carrier 716 and the system load rack 710. In an embodiment, exchange robot 712 includes one or more rotatable arms. For example, exchange robot may have a first arm 725 that is coupled to the robot 712 and the end-effector 718. In an embodiment, the first arm 725 is coupled to the end-effector 718 by a rotatable joint 726 that allows the end-effector 718 to rotate about axis 728. Embodiments also include a first arm 725 that is rotatable about axis 727 of the exchange robot 712. In an embodiment, robot mount 719 provides motion in the X and Z-directions. For example, robot mount 719 may have one or more actuators. For example, the actuators may be a hydraulic actuator or a mechanical actuator. Embodiments may include actuators such as a hydraulic piston or a lead screw. The system load rack 710 and the workpiece carrier 716 may be substantially similar to the ones described above with respect to FIG. 5A.

Referring now to operation 480 of flowchart 400, and corresponding FIG. 7A, the exchange robot 712 contacts a workpiece 730 stored in the workpiece carrier 716. In an embodiment, contacting the workpiece 730 includes inserting the end-effector 718 of the exchange robot 712 into the workpiece carrier 716 below a bottom surface of the workpiece 730. The exchange robot 712 is then raised in the Z-direction to bring the end-effector 718 into contact with the bottom surface of the workpiece 730.

Referring now to operation 482 of flowchart 400, and corresponding FIG. 7B, the exchange robot 712 lifts the workpiece off of the slot 720 on which it was positioned by displacing the exchange robot 712 in the Z-direction and removes the workpiece 730 from the workpiece carrier 716. In an embodiment, removing the workpiece 730 includes moving the exchange robot 712 in the X-direction away from the workpiece carrier 716. As the exchange robot 712 is displaced away from the workpiece carrier 716, the end-effector 718 removes workpiece 730 out the opening of the workpiece carrier 716 proximate to the exchange robot 712. In an embodiment, the exchange robot 712 may remove the workpiece 730 from the workpiece carrier 716 by rotating the first arm 725 around axis 727 and rotating the end-effector 718 around axis 728. In embodiments, rotation of the first arm 725 and the end-effector 718 may be accompanied by lateral displacement of the exchange robot 712 in the X-direction. In an embodiment, friction provides sufficient force to secure the workpiece 730 to the end-effector 718 during the transfer process. In an additional embodiment, the end-effector 718 includes a vacuum or an electro-magnetic gripping component to secure the workpiece 730 during the transfer process.

Referring now to operation 484 of flowchart 400, and corresponding FIG. 7C, the exchange robot 712 inserts the workpiece 730 into the system load rack 710. The exchange robot 712 is lowered in the Z-direction by the exchange robot 712 to allow the workpiece 730 to rest on a slot 721. As described above, the system load rack 710 includes slots 721 with a pitch that is greater than 10 mm. The increased pitch of the slots 721 in the system load rack 710 provides adequate spacing to allow a factory interface wafer handling robot to reliably pick up individual workpieces 730.

After placing the workpiece 730 on a slot 721, the end-effector 718 is removed from the system load rack 710 as indicated at operation 486 of flowchart 400. In an embodiment the loader interface 705 is indexed after the end-effector 718 is removed from the system load rack 710 in order to prepare for transferring another workpiece 730 as indicated at operation 488 of flowchart 400. In an embodiment, the exchange robot 712 and the workpiece carrier 716 are indexed in the Z-direction. For example, the docking station 713 that supports the workpiece carrier 716 is raised in the Z-direction by the indexing mechanism 714 in order to align an occupied slot 720 of the workpiece carrier 716 with an empty slot 721 of the system load rack 710. In such embodiments, the robot mount 719 is also indexed to align the end effector 718 with the next workpiece 730 that will be transferred. In an additional embodiment, the system load rack 710 may be indexed in the Z-direction in order to provide access to an open system load rack slot 721. Indexing the loader interface 705 may also include changing the positions in the Z-direction of system load rack 710 and the workpiece carrier 716.

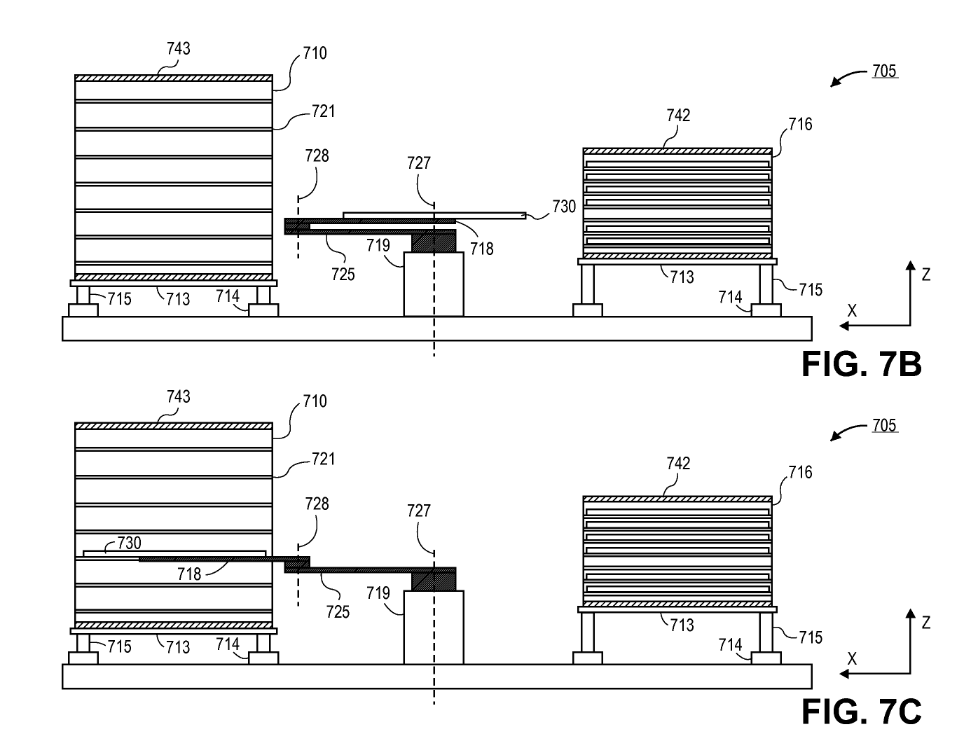

According to an additional embodiment depicted in FIG. 8, two workpiece carriers 816 and two exchange robots are located in the loader interface 805. A first workpiece carrier 816 may be positioned between a system load rack 810 and a first exchange robot 812, and a second workpiece carrier 816 may be positioned on the opposite side of the loader interface 805 between the system load rack 810 and a second exchange robot 812. A loader interface 805 according to such embodiments may implement a workpiece transfer process substantially similar to those described above with respect to flowchart 400. In an embodiment, both exchange robots 812 are able to transfer workpieces 830 from their respective workpiece carriers 816 to the system load rack 810 at the same time. Additional embodiments include operating one exchange robot 812 to transfer workpieces 830 while an empty workpiece carrier 816 on the opposite side of the loader interface 805 is replaced with a workpiece carrier 816 containing additional workpieces 830. Accordingly, the loader interface is capable of continuously operating without having to pause in order to replenish the supply of workpieces 830.

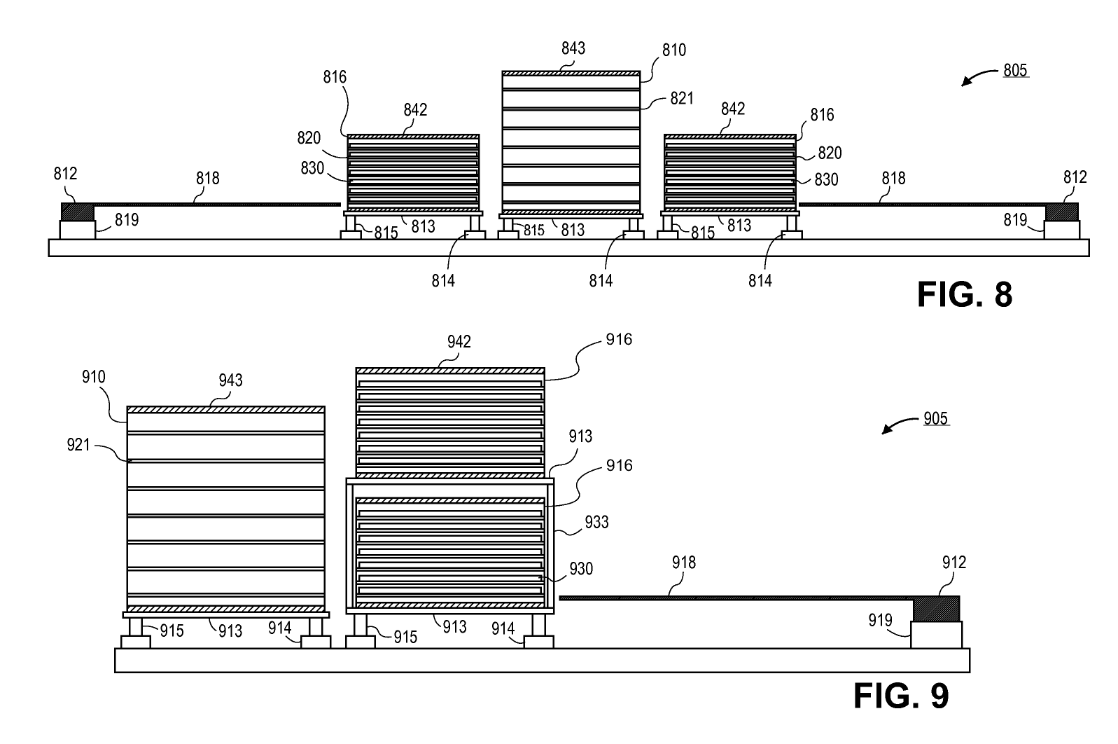

According to an additional embodiment, illustrated in FIG. 9, two or more docking stations 913 may be positioned on top of one another. For example, a second docking station 913 may be elevated above the first docking station 913 by vertical supports 933. A loader interface 905 according to such embodiments may implement a workpiece transferring process substantially similar to those described above with respect to flowchart 400. Such an arrangement allows the lower workpiece carrier 916 to be removed after it is emptied without interrupting the transfer of workpieces 930 stored in the upper workpiece carrier 916. Accordingly, the supply of workpieces 830 can be replenished without pausing the transfer process, thereby increasing throughput.

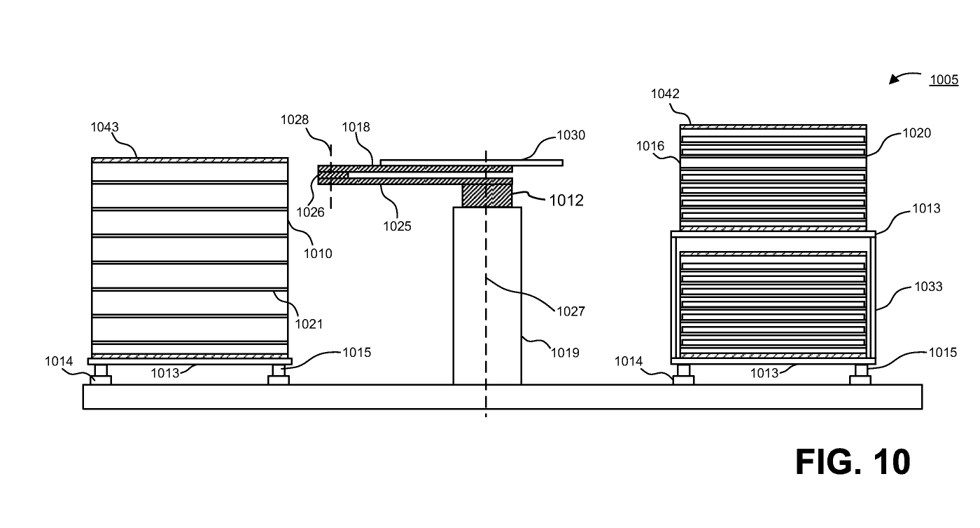

According to an additional embodiment, illustrated in FIG. 10, two or more docking station 1013 may be positioned on top of one another in substantially the same configuration as described above with respect to FIG. 9. A loader interface 1005 according to such embodiments may implement a workpiece transferring process substantially similar to those described above with respect to flowchart 400. More specifically, embodiments such as those illustrated in FIG. 10 may implement a workpiece transferring process substantially similar to those described above with respect to FIGS. 7A-7C in which an exchange robot 1012 that includes one or more rotatable arms is positioned between the workpiece carrier 1016 and the system load rack 1010. Such an arrangement allows the lower workpiece carrier 1016 to be removed after it is emptied without interrupting the transfer of workpieces 1030 stored in the upper workpiece carrier 1016. Accordingly, the supply of workpieces 830 can be replenished without pausing the transfer process, thereby increasing throughput. Furthermore, in an embodiment, the exchange robot 1012 can be indexed in the Z-direction, such that it is able to access each slot 1020 of both workpiece carriers 1016 and each slot 1021 of the system load rack 1010. Accordingly, neither the workpiece carriers 1016, nor the system load rack 1010 needs to be indexed in order to transfer workpieces 1030.

Embodiments of the present invention may be provided as a computer program product, or software, that may include a machine-readable medium having stored thereon instructions, which may be used to program a computer system (or other electronic devices) to perform a process according to embodiments of the present invention. In one embodiment, the computer system is coupled with loader interface 305 described in association with FIG. 3A. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

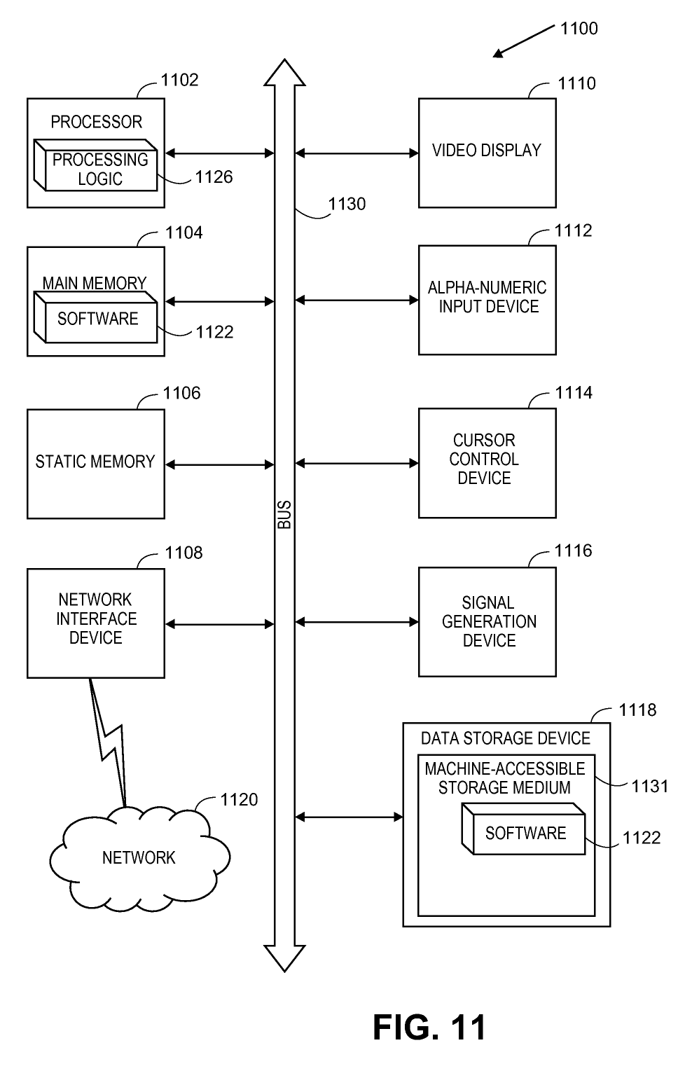

FIG. 11 illustrates a diagrammatic representation of a machine in the exemplary form of a computer system 1100 within which a set of instructions, for causing the machine to perform any one or more of the methodologies described herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies described herein.

The exemplary computer system 1100 includes a processor 1102, a main memory 1104 (e.g., read-only memory (ROM), flash memory, dynamic random access memory (DRAM) such as synchronous DRAM (SDRAM) or Rambus DRAM (RDRAM), etc.), a static memory 1106 (e.g., flash memory, static random access memory (SRAM), etc.), and a secondary memory 1118 (e.g., a data storage device), which communicate with each other via a bus 1130.

Processor 1102 represents one or more general-purpose processing devices such as a microprocessor, central processing unit, or the like. More particularly, the processor 1102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1102 may also be one or more special-purpose processing devices such as an application specific integrated circuit (ASIC), a field programmable gate array (FPGA), a digital signal processor (DSP), network processor, or the like. Processor 1102 is configured to execute the processing logic 1126 for performing the operations described herein.

The computer system 1100 may further include a network interface device 1108. The computer system 1100 also may include a video display unit 1110 (e.g., a liquid crystal display (LCD), a light emitting diode display (LED), or a cathode ray tube (CRT)), an alphanumeric input device 1112 (e.g., a keyboard), a cursor control device 1114 (e.g., a mouse), and a signal generation device 1116 (e.g., a speaker).

The secondary memory 1118 may include a machine-accessible storage medium (or more specifically a computer-readable storage medium) 1131 on which is stored one or more sets of instructions (e.g., software 1122) embodying any one or more of the methodologies or functions described herein. The software 1122 may also reside, completely or at least partially, within the main memory 1104 and/or within the processor 1102 during execution thereof by the computer system 1100, the main memory 1104 and the processor 1102 also constituting machine-readable storage media. The software 1122 may further be transmitted or received over a network 1120 via the network interface device 1108.

While the machine-accessible storage medium 1131 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

In accordance with an embodiment of the present invention, a machine accessible storage medium has instructions stored thereon which cause a data processing system to perform a method of transferring a workpiece from a workpiece carrier to a system load rack in a loader interface. The method involves contacting a workpiece in a workpiece carrier with an exchange robot. The method also involves removing the workpiece from the workpiece carrier with the exchange robot. The method also involves inserting the workpiece into a system load rack. The method also involves removing the exchange robot from the system load rack. The method also involves indexing the loader interface.

1. A method of transferring a workpiece comprising:
contacting a workpiece in a workpiece carrier with an end-effector coupled to an exchange robot, wherein the workpiece is positioned in one of a plurality of workpiece carrier slots spaced apart from each other by a first pitch;
removing the workpiece from the workpiece carrier with the end-effector;
inserting the workpiece into a system load rack with the end-effector, wherein the system load rack has a plurality of system load rack slots that are spaced apart from each other by a second pitch that is larger than the first pitch, and wherein the workpiece carrier and the system load rack are outside of a factory interface; and
removing the end-effector from the system load rack.

2. The method of claim 1, wherein contacting the workpiece includes lifting the workpiece off of the workpiece carrier slot with the end-effector.

3. The method of claim 2, wherein removing the workpiece from the workpiece carrier comprises advancing the end-effector and the workpiece through the workpiece carrier.

4. The method of claim 1, wherein contacting the workpiece includes contacting an edge of the workpiece with the end-effector.

5. The method of claim 4, wherein the end-effector secures the workpiece with an electromagnetic force, a vacuum force, or a mechanical force.

6. The method of claim 4, wherein removing the workpiece from the workpiece carrier comprises pushing the workpiece through the workpiece carrier along the workpiece carrier slot.

7. The method of claim 1, further comprising indexing the workpiece carrier subsequent to inserting the workpiece into the system load rack.

8. The method of claim 1, further comprising indexing the system load rack subsequent to inserting the workpiece into the system load rack.

9. The method of claim 1, wherein the first pitch is 10 mm or less and the second pitch is between 15 mm and 20 mm.

10. The method of claim 1, wherein the workpiece comprises a carrier ring, a substrate, and a backing tape.

11. The method of claim 10, wherein the workpiece has a thickness greater than approximately 1.0 mm.

12. A loader interface comprising:
a first docking station for receiving one or more workpiece carriers having a plurality of workpiece carrier slots spaced apart by a first pitch;
a system load rack with a plurality of system load rack slots each sized for receiving a workpiece, wherein the plurality of system load rack slots are spaced apart by a second pitch that is greater than the first pitch, and wherein the first docking station and the system load rack are outside of a factory interface; and
a first exchange robot having an end-effector sized to transfer a workpiece stored in a workpiece carrier to one of the system load rack slots in the system load rack.

13. The loader interface of claim 12, wherein the first exchange robot is coupled to a robot mount that can displace the exchange robot in two or more directions.

14. The loader interface of claim 12, wherein the system load rack is coupled to an indexing mechanism that raises and lowers the system load rack.

15. The loader interface of claim 12, wherein the first docking station is positioned between the system load rack and the first exchange robot.

16. The loader interface of claim 15, wherein the end-effector has a length greater than a width of the first docking station.

17. The loader interface of claim 12, wherein the first docking station is coupled to an indexing mechanism that that raises and lowers the docking station.

18. The loader interface of claim 12, wherein the first pitch is 10 mm or less and the second pitch is between 15 mm and 20 mm.

19. The loader interface of claim 12, further comprising:
a second docking station for receiving one or more workpiece carriers having a plurality of workpiece carrier slots spaced apart by a first pitch of 10 mm or less positioned on a side of the loader interface opposite to the first docking station; and
a second exchange robot having an end effector sized to transfer a workpiece stored in a workpiece carrier to one of the system load rack slots in the system load rack positioned on a side of the loader interface opposite to the first exchange robot.

20. A loader interface comprising:
a first docking station for receiving one or more workpiece carriers having a plurality of workpiece carrier slots spaced apart by a first pitch, wherein the first docking station is coupled to a first indexing mechanism comprising one or more actuators for raising or lowering the first docking station;
a system load rack with a plurality of system load rack slots each sized for receiving a workpiece, wherein the plurality of system load rack slots are spaced apart by a second pitch that is greater than the first pitch, wherein the system load rack is coupled to a second indexing mechanism comprising one or more actuators for raising or lowering the system load rack, and wherein the first docking station and the plurality of system load racks are outside of a factory interface; and
a first exchange robot having an end-effector sized to transfer a workpiece stored in a workpiece carrier to one of the system load rack slots in the system load rack, wherein the end-effector has a length greater than the width of the first docking station and is coupled to two or more actuators that displace the first exchange robot in at least two directions.
